(19) United States
(12) Patent Application Publication
(10) Pub. No.: US 2022/0336174 A1
(43) Pub. Date: Oct. 20, 2022

(54) QUICK-BREAK DISCONNECT SWITCH

(71) Applicant: PETER LELL, MOOSBURG (DE)

(72) Inventor: PETER LELL, MOOSBURG (DE)

(21) Appl. No.: 17/762,961

(22) PCT Filed: Oct. 2, 2020
(86) PCT No.: PCT/EP2020/077628

§ 371 Date: Mar. 23, 2022

(30) Foreign Application Priority Data
Oct. 2, 2019 (EP) 19201212.8

(51) Int. Cl. H01H 39/00

(52) U.S. Cl. CPC H01H 39/006

(57) ABSTRACT

The present invention relates to a quick circuit breaker, that is, a switch with which an electrical circuit can be disconnected particularly quickly. Such switches are occasionally also referred to as pyrotechnic disconnect devices or as electrical interrupting switching elements. In particular, it is a quick circuit breaker (10) which comprises a current supply contact and a current discharge contact which are connected by a conductor (20) and in which the conductor (20) is guided through a separation chamber (12) and an expansion vessel (18) being provided in the separation chamber (12), the expansion vessel (18) being able to be expanded by an explosive charge. It is further about a method for emergency disconnection of a circuit.

### FIELD OF THE INVENTION

The present invention relates to a quick circuit breaker, that is, a switch with which an electrical circuit can be disconnected particularly quickly, even at high current intensities and high isolating voltages. The switch is suitable for DC and AC circuits. The switch typically uses a small amount of explosive material for this purpose. Such switches are occasionally also referred to as pyrotechnic disconnect devices or as electrical interrupting switching elements. In the field of e-mobility, which is becoming increasingly important, said switches can be used in particular to protect electric drives, especially in electric cars, electric trucks or electric buses. If a vehicle that is powered in this way has an accident, it is important and necessary to quickly disconnect the power source from the vehicle wiring. The corresponding issues also arise when propelling ships by means of electric motors or now also when propelling airplanes by means of electric motors, but also with the corresponding tasks in control cabinets in general.

### BACKGROUND OF THE INVENTION

Many circuit breakers use the action of propellant charges on a plunger. After the plunger's acceleration and the pressure exerted thereon, circuit breakers are in any case able to quickly interrupt a circuit, even when high currents are flowing.

European patent application EP 563 947 A1 discloses a method of protecting circuits carrying high currents and also discloses a high current fuse element. A pyrotechnic charge is ignited to cut through the conductor. Said charge accelerates a cutting punch. The cutting punch mechanically cuts through a conductor section.

The German patent application DE 196 16 993 A1 discloses a pyrotechnic safety element for circuits. A pyrotechnic charge is also used here. Said pyrotechnic charge accelerates a plastic plunger, which guides a knife-like separating element, which in turn can cut through a conductor.

The German patent specification DE 44 38 157 also discloses a pyrotechnic disconnect device which is suitable for accelerating an active part, which essentially has the shape of a plunger, for cutting through a conductor.

These solutions all work on the basic principle of a plunger-operated circuit breaker. The acceleration of the plunger mass is a disadvantage since it is important to disconnect a circuit very quickly within milliseconds. Accelerating a mass inevitably delays the process. Furthermore, the plunger must be guided cleanly in a respective separation chamber in order to enable rapid movement. In addition, it is still necessary to provide sealing devices, for example, between the plunger and the propellant charge.

German publication DE 44 02 994 A1 discloses an electrical safety switch for motor vehicles which can be described as being plunger-free. In this case, two conductors are connected to one another such that a tapered end of one conductor protrudes into the receiving space of another conductor. A gas generator, which acts as a propellant charge, is provided in said receiving space. With such a solution, however, exhaust gases, which are produced by a propellant charge, escape into the then open space between two conductors. Also, the separation of the conductors does not proceed in a well-defined manner. If the separation is insufficient, arcing can occur very quickly.

The present invention would like to offer a quick circuit breaker that can be produced inexpensively and reliably, and which avoids the disadvantages of the prior art. In particular, the circuit breaker can work without a plunger, so that separation with little accelerated mass is possible. The separation is intended to transfer the conductor to be separated into a reliable, predefined separation state, thereby minimizing arcing effects, as would occur primarily in direct current circuits (DC circuits) when the circuit is disconnected. Furthermore, the escape of exhaust gases from the propellant charge or contamination particles should be avoided, as should the contact of the exhaust gases with the separation point(s).

This object is achieved by a quick circuit breaker according to claim 1. Advantageous developments are specified in the dependent claims. A method for circuit disconnection according to method claim 11 and its dependent claims also has the corresponding advantages.

### DESCRIPTION

The quick circuit breaker should comprise a current supply contact and a current discharge contact. However, these designations are not necessarily intended to define a current direction; the circuit breaker can usually become effective independently of a specific current direction. Said contacts can be provided directly on the circuit breaker, or the circuit breaker can also have line sections which in turn only have said contacts. The two contacts are connected by a conductor. Said conductor is often a copper or aluminum conductor. However, another material, in particular another metallic or at least electrically conductive material, is also suitable.

The quick circuit breaker comprises a separation chamber. Said disconnect chamber in turn comprises an interior space. The interior space can have different shapes, often being cuboid. The conductor is fed through the separation chamber. The conductor is preferably routed exactly or substantially centrally through the separation chamber. This results in a mirror-symmetrical position, at least in one sectional plane.

According to the invention, an expansion vessel is provided in the separation chamber. The expansion vessel may contain an explosive charge. Alternatively, the explosive charge can be accommodated in a vessel adjacent to the expansion vessel, for example, together with an ignition charge. In any case, the explosive charge should be able to expand the expansion vessel if there is an explosion.

In contrast to the prior art, the explosive charge is not provided directly in the separation chamber, but in its own vessel.

The explosion of the explosive charge causes the mechanical separation of the conductor. This happens with expansion of the expansion vessel. The expansion vessel in this case can completely enclose the explosive charge even after the explosion.

This aspect leads to further fundamental advantages of the invention: The circuit breaker can be built gas-tight and can therefore be used at very low ambient pressures (for example, in aviation). Exhaust gas must be able to escape in switches of the prior art. Said switches therefore cannot be built gas-tight and can be used at very low ambient pressures.

The expansion vessel can, for example, comprise a bellows. Such a bellows facilitates rapid expansion. The expansion vessel should be able to expand, for example, to more than 200%, 300%, 400%, 500% or up to 1000% of its original volume. This should preferably be done non-destructively. The expansion vessel can also be elastic, so that its volume is reduced again after the explosion. However, elasticity is not required. The expansion vessel can usefully be made of metal or of a non-metal. Useful metals are steels, generally thin steels, and especially stainless steel. Alternatively, the expansion vessel can also be made of bronze or copper. Rubber, natural rubber, silicone or even TPE plastic are appropriate for the non-metals. Plastics such as polyoxymethylene (POM), polyamide 6 (PA 6) or ABS could also be considered.

If an electrically conductive material is used for the expansion vessel, this must generally be electrically insulated on the outside with an electrically non-conductive layer so that the remaining contact pieces are not electrically bridged after the conductor has been separated.

The expansion vessel is usefully lighter than the conductor section running in the separation chamber. Due to this low weight, a rapid expansion of the explosive charge is also provided in relation to the mass of the severing conductor section. A rather heavy expansion vessel would cause the conductor to be cut through in the manner of a plunger. A bellows made of metal can be designed in a similar way. However, conductor separation such as by a sharp-edged plunger-like section would not be required within the scope of the present invention. The conductor separation occurs primarily through the rapid expansion of the explosive material in the specified space of the separation chamber, in other words, through a pressure wave.

It is useful if the conductor runs through the separation chamber along an axis in a first direction. The separation chamber and in particular the position of the expansion vessel can usefully be designed such that the separation takes place with a completely, or essentially, or at least predominantly radial component in relation to said axis. A conductor section to be cut away can then be displaced radially. In this case, the conductor can be bent, so that only a certain segment is radially displaced, or a section can be cut away from the conductor on two sides, which segment is radially displaced overall.

It can be useful if the conductor softens mechanical weakening elements. Such weakening elements reduce the conductor material to be separated without significantly increasing the electrical contact resistance of the conductor material. Said weakening elements can comprise holes, grooves, partial cuts or notches. Said weakening elements also serve to make the separation of the conductor predictable, easier and favorable in advance.

A hole has the added benefit of allowing air flow through the conductor. If the conductor moves quickly or there is a gap between the conductors, there is less flow resistance. Even if the conductor moves into an extinguishing medium, the flow resistance and thus the resistance to the desired translational movement of the conductor can be significantly reduced through the hole. In addition, holes are points of weakness due to the removal of the material, at which points the material can break particularly easily.

Moreover, weakening elements can be provided in the form of grooves or notches. A groove is to be understood herein as a slit of a certain depth (which appears as a blind hole in cross-section), but which also has a uniform thickness in cross-section. A notch should be understood to mean a depression which is wider near the surface of the conductor than at a greater depth. Both are suitable weakening elements. Advantageously, notches make it possible to move entire sections of the conductor radially. If only one groove is provided, in particular a narrow groove, the radial displacement by tilting and canting can be made more difficult or impeded.

The conductor may also have a zone of increased resistance. For example, the conductor diameter can be reduced in such a zone. The weakening elements listed above can usefully be used to increase the electrical resistance. This leads to electrical heating of the conductor. The resulting heat can be used to ignite explosive material present there. For this purpose, the explosive material is preferably positioned close to the zone of increased resistance and in good thermal contact therewith.

There is also the advantageous possibility of optimizing the material of the expansion vessel for such a heat-triggered or “passive” explosion. In this case, the material of the expansion vessel as a whole can be adapted to this task, or sections of the expansion vessel, namely on the contact surface with the conductor, have a material that differs from the rest of the expansion vessel. Suitable materials here are copper, brass, aluminum, silver or bronze.

It is also possible for an additional contact layer to be applied to the expansion vessel. For example, a contact layer made of copper could be used for particularly good heat conduction. The heat-induced separation can be adapted particularly precisely to the needs of the circuit in this way.

This useful design shows further advantages of using an expansion vessel. For example, where a plunger is used, the plunger must almost inevitably be applied between the explosive charge and the conductor. However, the plunger prevents the explosive charge from being positioned locally close to the conductor. This is possible by dispensing with a plunger. The triggering of the circuit disconnect by conductor heating is particularly advantageous. Due to the passive triggering of the explosive charge or the circuit breaker that is present here, it makes it possible to avoid overheating of the circuit or a current source short-circuited here due to excessive currents, without a complicated detection and evaluation of the currents and/or circuit being necessary.

It can also be useful to provide parts of the explosive charge inside the expansion vessel and to provide parts of the explosive charge outside of the expansion vessel. For example, an explosive charge can be provided in a blind hole or a similar recess in the conductor. Said explosive charge then heats up quickly through direct contact with the conductor. Their explosion can, by heat transfer, cause the explosion of the remaining explosive charge in the separation vessel. For example, a hole can also be provided for this purpose, through which hole a jet of hot gas reaches the interior of the expansion vessel. Such a hole is not absolutely necessary, since an explosion of explosive material, which is provided inside the expansion vessel, can also be triggered quickly and reliably by thermal heating through the material of the expansion vessel.

According to a further advantageous embodiment of the invention, the separation chamber can comprise an extinguishing medium. Said extinguishing medium can, for example, be arranged below the conductor, that is, on the side of the conductor facing away from the expansion vessel—or it more or less fills the entire interior space of the circuit breaker outside of the expansion vessel. Filling levels of 10% to almost 100% of the free internal volume of the circuit breaker are advantageous here.

The present invention also relates to a method for emergency disconnection of a circuit, which comprises the following steps:
a. conducting the current through a conductor section
b. guiding the conductor section through a separation chamber
c. providing an expansion vessel in the separation chamber
d. holding an explosive material on or in the expansion vessel
e. igniting the explosive material
f. cutting through the conductor section

The explosive material should be kept on or in the expansion vessel such that the expansion vessel can be expanded by the reaction of the explosive material.

Preferably, the steps are performed in context and in the order in which they are listed. The method is to be understood in relation to the quick circuit breaker according to the invention. This means that features of the design of the quick circuit breaker are to be transferred analogously to the method, and features of the method are to be transferred analogously to features of the quick circuit breaker.

A method in which the explosive material remains completely in the vessel after the explosion is also useful.

Also useful is a method in which, after the conductor has been cut through, a first conductor end and a second conductor end are produced, and the expansion vessel mechanically separates the first conductor end and the second conductor end. The expansion vessel thus expands between the conductor ends. In general, mechanical separation is to be understood here as meaning that the expansion vessel cuts through an imaginary connecting line between the conductor ends and/or cuts through along the original axial course axis of the conductor.

In particular, a method in which the explosive material is ignited by an electrical ignition pulse is also useful. Alternatively or additionally, but usually as alternatively, the explosive material can be ignited by heating a conductor section. A conductor section having an increased electrical resistance is particularly suitable.

Usefully, this is also a method in which the expansion vessel nestles against the inner walls of the separation chamber in whole or in sections.

Before the explosion, the expansion vessel is located in a partial volume of the separation chamber. This partial volume usefully makes up less than 80% or else less than 60% or even less than 40% of the total volume of the separation chamber.

The separation chamber should further have a so-called first volume. Said volume is also delimited by the area that cuts through the conductor in the middle and is perpendicular to the direction of expansion of the expansion vessel. The first volume should contain the expansion vessel. Based on the first volume, it is useful if the expansion vessel occupies less than 80% or 60% or even 40% of the first volume.

After the explosion, the expansion vessel fills up a larger volume of the separation chamber. In this case, it can fill almost the full volume of the separation chamber and then nestle almost completely or completely against the inner walls of the separation chamber. Alternatively, this happens at least in sections. The nestling to the inner walls of the separation chamber and the appropriate selection and positioning of the expansion vessel make it easier for the expansion vessel walls not to burst or become leaky in some other way. The expansion vessel then only has to move with the expanding front of the propellant material in the explosion phase until it hits a separating wall section. From this point in time, the pressure of the explosion is absorbed by the inner walls or at least an inner wall section of the separation chamber. Accordingly, the walls of the expansion vessel, while having some degree of resistance to an explosion, need not be overly strong. It is sufficient if the material itself is not very (pressure) resistant, but can be stretched quickly. This applies in particular to rubber materials. The expansion vessel can then form a kind of balloon that is designed for a one-time rapid expansion, but does not have to withstand high pressures or at least not necessarily in the long term.

An explosive charge is generally understood here to mean a substance which expands quickly and greatly when it is activated accordingly. A substance or mixture of substances which can cause the expansion vessel to expand as a result of internal pressure can be considered. Gases or vapors can be generated in the process. Nitrocellulose powder or double base powder (these are mixtures of NC and NGL) are useful here, but above all the well-known ignition and detonation materials such as ZPP (zirconium potassium perchlorate), silver azide, hexogen or octogen.

Mixtures containing lead, such as lead azide, could also be used, but said mixtures should remain free of heavy metals. Gases or, in particular, in liquid form can also be used here.

Activation is usually by an igniter or detonator. The igniter can contain a hot wire or explosive wire or can be ignited by an electrical discharge. A solid or liquid or other gaseous substance can also be admixed to a gas, in particular an oxidizing agent. Alternative or additionally, an explosion can also be triggered passively, that is, by simply heating up an explosive substance. An explosive substance can also be provided in two regions, with a first explosive being detonated first and said explosion triggering the explosion of a second explosive substance.

The optionally provided extinguishing agent should be matched to the explosive charge. In principle, it can be liquid, gaseous, gel-like, foam-like or multi-fibrous.

Further features, but also advantages of the invention, result from the drawings listed below and the associated description. Features of the invention are described in combination in the figures and in the associated descriptions. However, these features can also be comprised in other combinations by a subject matter according to the invention. Each disclosed feature is therefore also to be regarded as being disclosed in technically meaningful combinations with other features. Some of the illustrations are slightly simplified and schematic:

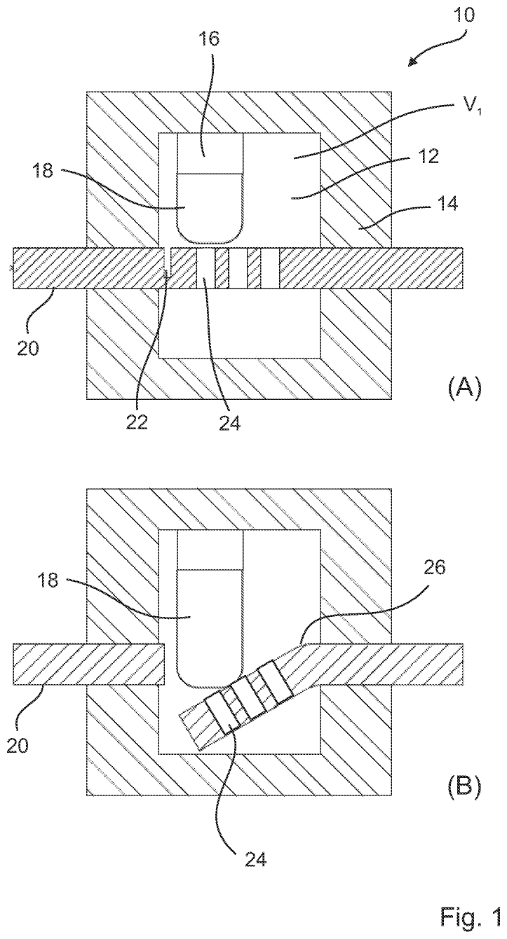

FIG. 1 is a cross-sectional view of a circuit breaker according to the present invention, shown in view (A) before separation and in view (B) after separation.

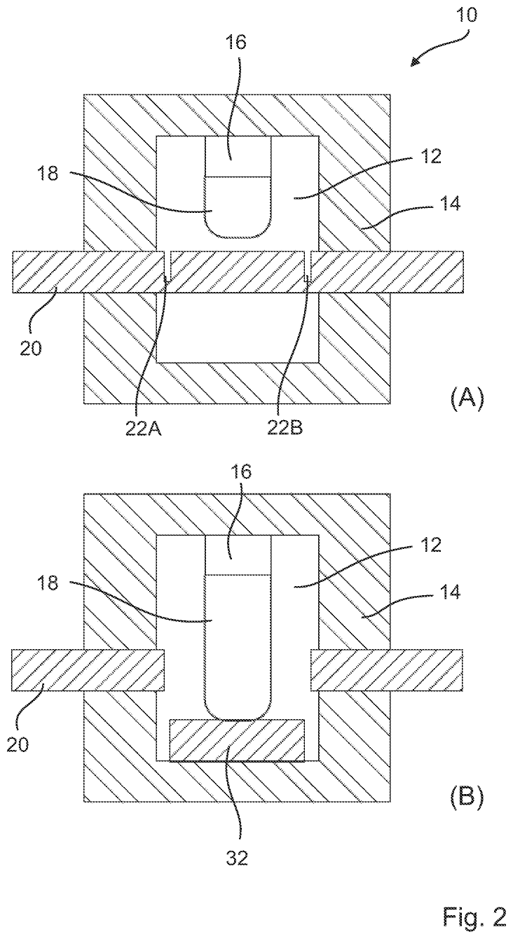

FIG. 2 is a cross-sectional view of an alternative circuit breaker according to the present invention, shown in view (A) before separation and in view (B) after separation.

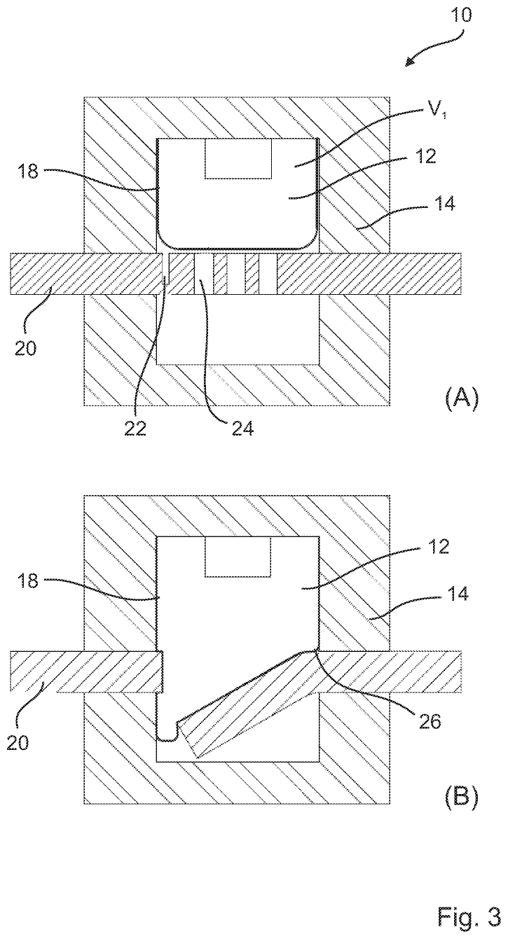

FIG. 3 is a cross-sectional view of an alternative circuit breaker according to the present invention, shown in view (A) before separation and in view (B) after separation.

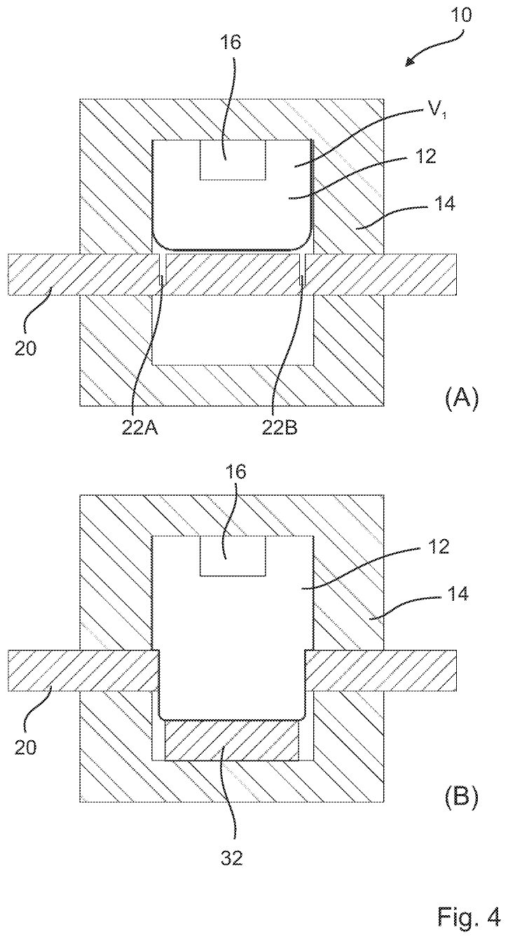

FIG. 4 is a cross-sectional view of an alternative circuit breaker according to the present invention, shown in view (A) before separation and in view (B) after separation.

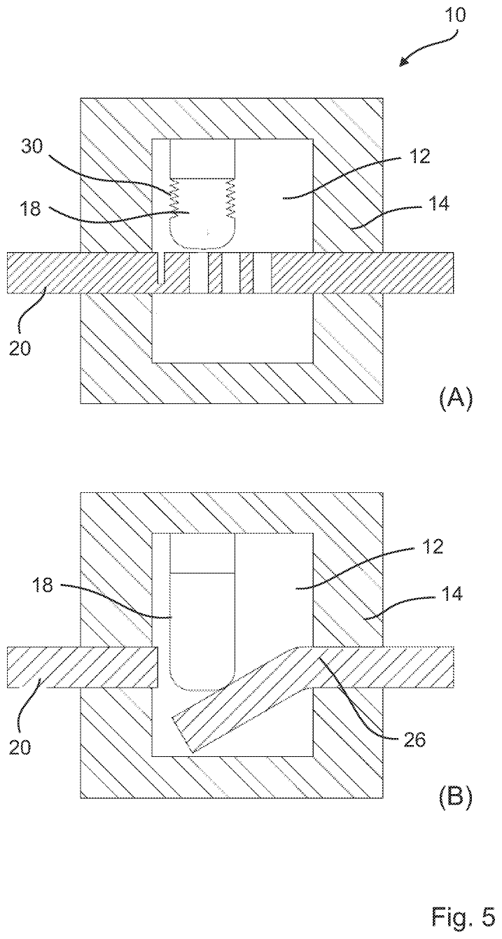

FIG. 5 is a cross-sectional view of an alternative circuit breaker according to the present invention, shown in view (A) before separation and in view (B) after separation.

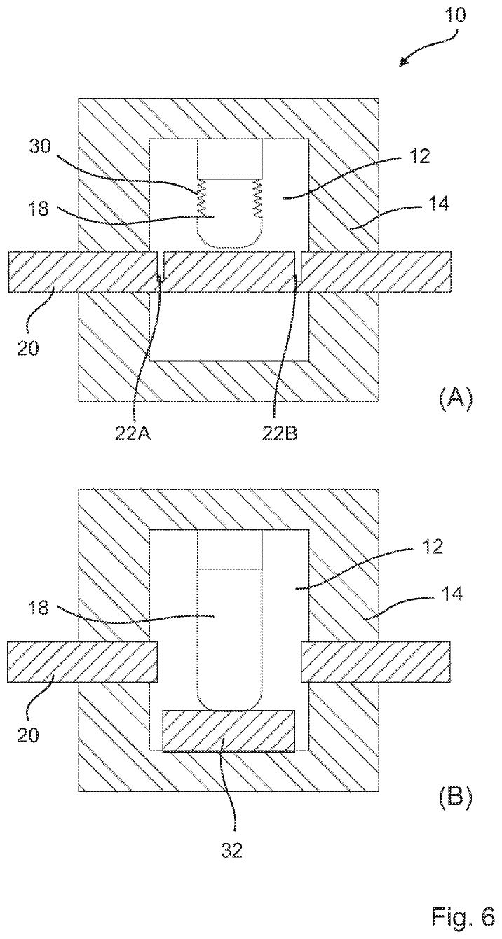

FIG. 6 is a cross-sectional view of an alternative circuit breaker according to the invention, shown in view (A) before separation and in view (B) after separation.

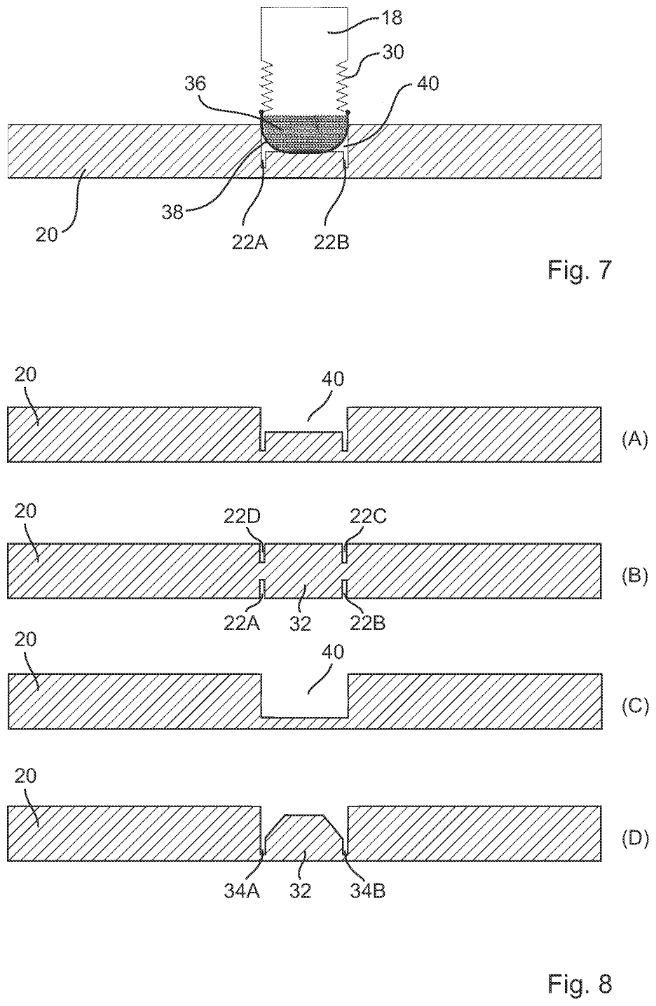

FIG. 7 shows a cross-sectional view of parts of a circuit breaker according to the invention, which can be ignited passively.

FIG. 8 provides cross-sectional views of various conductors, each having different weakening elements.

FIG. 1 shows a quick circuit breaker 10 according to the invention in cross section. View (A) shows the quick circuit breaker 10 prior to its tripping, that is, prior to the separation of the conductor.

The quick circuit breaker 10 comprises the separation chamber 12 which is surrounded by the separation chamber housing 14. An ignition element 16 is mounted in the separation chamber 12. The expansion vessel 18 is provided following the ignition element 16. The conductor 20 runs through the separation chamber. The conductor 20 is equipped with various weakening elements, namely with the groove 22 and with holes 24.

The separation chamber 12 has a first volume Vi, which in this cross section is delimited at the bottom by the conductor 20 and is otherwise delimited by the walls of the separation chamber 12. The expansion vessel 18 takes up only a small space of said first volume Vi, significantly less than 50%.

Triggered by an ignition, a significant (explosive) increase in volume of the expansion vessel can occur. For this purpose, the expansion vessel 18 or the chamber around the ignition element 16 contains an explosive material that is not shown in detail. The circuit breaker 10 is brought into the state shown in view (B) by said explosion. (Elements that have not changed are no longer described and explained.) The expansion vessel 18 now occupies a much larger volume. The conductor 20 is cut through. The bend 26 occurs here. This completely separates the conductor 20 at the surfaces of separation 28a and 28b and creates a spacing between the surfaces of separation that prevents electrical flashover.

It should be borne in mind that the circuit breaker according to the invention can comprise further elements. It is shown here only schematically and in a slightly simplified manner. For example, terminals could be provided at the conductor ends, and the ignition element itself can have a plurality of parts. However, the circuit breaker 12 shown already implements all the essential elements of the invention.

Furthermore, the free volume of the assembly above and/or below the conductor 20 can be filled with a gaseous, liquid, powdery or gel-like extinguishing fluid (not shown here), or mixtures thereof.

FIG. 2 shows another circuit breaker 10 according to the invention in a corresponding view. In this case, the conductor 20 has been provided two grooves 22A and 22B. A conductor section is formed between the grooves 22A and 22B. As can be seen in view (B), said conductor section 32 can be displaced transversely as a whole by the explosion. The advantage here is that the circuit is opened at 2 points during the separation process, so that the voltage applied to the circuit breaker is virtually halved for each opening point and thus only half the energy is converted per opening point, the energy having been stored as magnetic energy in the circuit inductance at the moment of separation, as is the case with only one separation point. Circuits can thus still be opened at slightly higher voltages without an arc remaining at the separation points after opening or separation, as would happen in particular when DC circuits are separated.

FIG. 3 shows another embodiment of the invention in an analogous sectional representation. The conductor is designed essentially as shown in FIG. 1. However, the expansion vessel is larger here. Before the explosion, the expansion vessel essentially occupies the entire first volume Vi, which the separation chamber 12 above the conductor 20 makes available.

View (B) shows the situation after the explosion. The expansion vessel 18 has expanded; as it expands, it nestles against the inner walls of the separation chamber and presses against the conductor 20. This leads analogously to the formation of a bend 26 in the conductor. The expanded expansion vessel suppresses spark flashover particularly efficiently.

FIG. 4 shows a further embodiment of the present invention in an analogous representation. An expansion vessel, which occupies a large volume, namely the entire first volume Vi above the conductor 20, has again been used here. This in turn is equipped with grooves, namely the grooves 22A and 22B. After the explosion, the large expansion vessel also causes the conductor piece 32 to break out on the conductor.

FIG. 5 shows a further alternative embodiment of the invention. An expansion vessel 18 which comprises a bellows 30 is used in this case. As shown in view (B), the expansion of the expansion vessel 18 due to the explosion in turn creates a bend 26 in the conductor 20. The expansion is allowed by the bellows 30 so that the corresponding folds disappear after the explosion as shown in view (B). Even after the explosion, the expansion vessel remains intact so that explosive material does not penetrate into the interior space of the separation chamber.

FIG. 6 shows yet another embodiment of the invention. Here, an expansion vessel 18 having a bellows is combined with a conductor 20, which in turn has two grooves, the grooves 22A and 22B. Due to the expansion of the expansion vessel, which in turn causes the folds of the bellows to disappear due to expansion, there is a complete transverse displacement of the conductor piece 32.

In the embodiments shown in FIG. 2 to FIG. 6, the free volume of the assembly above and/or below the conductor 20 can again be filled with a gaseous, liquid, powdery or gel-like extinguishing fluid (not shown here), also from mixtures thereof.

FIG. 7 shows a cross-sectional view of parts of a circuit breaker according to the invention, which can be ignited passively.

The representation of the quick circuit breaker 10 as a whole is dispensed with here. Depicted is the conductor 20 and its interaction with the expansion vessel 18. The expansion vessel 18 shown in turn comprises a bellows 30. This is useful if the expansion vessel is made of metal. There is often no need to provide such a bellows in an expansion vessel made of rubber. The expansion vessel 18 is filled with the explosive charge 36 in its lower region. Said explosive charge rests against the conductor via a contact track. The contact track 38 can be manufactured in one piece with the expansion vessel or applied to the outside of the expansion vessel as an additional track. A blind hole 40, which can partially accommodate the expansion vessel, is provided in the conductor 20. In addition, grooves 22A and 22B are provided in the conductor 20. On the one hand, this mechanical situation leads to a mechanical weakening of the conductor. Furthermore, a region of increased electrical resistance is generated by the blind hole 40 and by the grooves 22A and 22B. The conductor heats up quickly with a correspondingly high current flow in said region.

The geometry also has the advantageous effect in that the heat is quickly transferred to the expansion vessel 18 and the explosive charge 36 can be ignited there.

As already explained, but not shown here, it can also be useful to provide a second explosive charge outside of the expansion vessel 18 in the region of the blind hole and possibly also in the grooves 22A and 22B. The rapid ignition of such an explosive material outside of the expansion vessel 18 is particularly possible by mere heat transfer. An optional additional second explosive material that is also provided inside the expansion vessel is then particularly easily ignited by the first explosive material that is provided outside the expansion vessel 18.

If the bellows or the material of the expansion vessel is an electrically conductive material, it must be coated on the outside with an electrically non-conductive material, at least thinly, in order to not again electrically short-circuit the conductor that was initially separated after the circuit breaker has tripped. Essentially all available plastics, plastics and rubber types are suitable therefor.

FIG. 8 provides schematic cross-sectional views of further advantageous conductor shapes as may be used in conjunction with a speed circuit breaker within the scope of the present invention. Said conductors are particularly suitable for circuit breakers that can be passively ignited, as shown in FIG. 7.

View (A) shows a conductor which is equipped with a blind hole 40 and in which additional grooves 22A and 22B are provided. This view corresponds to the embodiment which has already been shown in FIG. 7.

View (B) shows an alternative design of the conductor in which four grooves are symmetrically provided, grooves 22A, 22B, 22C and 22D. A conductor piece which can be easily moved transversely is also defined by these grooves.

View (C) shows a conductor having a deep blind hole 40. Said blind hole can easily accommodate an expansion vessel. There are no additional grooves.

View (D) shows a conductor 20 in which two notches 34A and 34B are provided. Unlike grooves, which are of constant depth, the notches widen upwards. Notches thus have the advantage that the conductor piece 32 delimited by them can be moved transversely more easily. Tilting or possible jamming of the conductor piece 32 is thus efficiently avoided, even with a very rapid movement, as is typical for an explosion.

Overall, it can be seen how an efficiently operating speed circuit breaker which is suitable for both active and passive ignition can be produced according to the present invention.

### LIST OF REFERENCE NUMBERS

10 speed circuit breaker
12 separation chamber
14 separation chamber housing
16 ignition element
18 expansion vessel
20 conductor
22 groove
24 holes
26 bend
28 surfaces of separation
30 bellows
32 conductor piece
34 notch
36 explosive charge (in expansion vessel)
38 contact track
40 blind hole

1. A quick circuit breaker (10), which comprises a current supply contact and a current discharge contact, which are connected by a conductor (20), and in which the conductor (20) is guided through a separation chamber (12), and an expansion vessel (18) being provided in the separation chamber (12), the expansion vessel (18) being able to be extended by an explosive charge, the expansion vessel (18) consisting of an electrically conductive material and being coated or surrounded on the outside with an electrically non-conductive material.

2. The quick circuit breaker (10) according to claim 1, in which the expansion vessel (18) comprises a bellows (30).

3. The quick circuit breaker (10) according to claim 1, in which the expansion vessel (18) can expand to up to 500% of its original volume.

4. The quick circuit breaker (10) according to claim 1, in which the expansion vessel (18) is made of metal or rubber.

5. The quick circuit breaker (10) according to claim 1, in which the conductor section (32) within the disconnect chamber (12) has a first weight and the expansion vessel (18) has a second weight, the second weight being less than the first weight.

6. The quick circuit breaker (10) according to claim 1, in which the conductor (20) runs axially through the separation chamber (12) in a first direction and the expansion vessel (18) can exert a force having a substantially radial or predominantly radial component as it expands.

7. The quick circuit breaker (10) according to claim 1, the conductor (20) of which comprises at least one mechanical weakening element (22; 24; 34).

8. The quick circuit breaker (10) according to claim 7, in which at least one weakening element (22; 24; 34) is provided in the form of a groove (22), a hole (24) or a notch (34).

9. The quick circuit breaker (10) according to claim 1, in which the conductor (20) comprises a section of increased resistance.

10. The quick circuit breaker (10) according to claim 1, in which an extinguishing medium (41) is provided in the separation chamber (12).

11. The quick circuit breaker (10) according to claim 1, in which the conductor (20) is provided with more than one weakening element to create more than one separation point upon separation.

12. A method for emergency disconnection of a circuit in which current flows through a conductor (20), comprising the following steps:
a. conducting the current through a conductor section (32)
b. guiding the conductor section (32) through a separation chamber (12)
c. providing an expansion vessel (18) in the separation chamber (12), an expansion vessel (18) made of an electrically conductive material being coated or surrounded on the outside with an electrically non-conductive material
d. holding an explosive material in the expansion vessel (18)
e. igniting the explosive material
f. cutting through the conductor section (32)

13. The method according to claim 12, in which the explosive material remains entirely in the expansion vessel (18) after the explosion.

14. The method according to claim 12, in which, after the conductor (20) has been cut through, a first conductor end and a second conductor end are produced, and the expansion vessel (18) mechanically separates the first conductor end and the second conductor end.

15. The method according to claim 12, in which the explosive material is ignited by heating the conductor section (32).

16. The method according to claim 12, in which, after the explosive material has been ignited, at least parts of the walls of the expansion vessel (18) nestle against the inner walls of the separation chamber (12), at least in sections.

17. The quick circuit breaker (10) according to claim 2, in which the expansion vessel (18) can expand to up to 500% of its original volume.

18. The quick circuit breaker (10) according to claim 2, in which the conductor (20) runs axially through the separation chamber (12) in a first direction and the expansion vessel (18) can exert a force having a substantially radial or predominantly radial component as it expands.

19. The quick circuit breaker (10) according to claim 2, the conductor (20) of which comprises at least one mechanical weakening element (22; 24; 34).

20. The quick circuit breaker (10) according to claim 10, in which the conductor (20) is provided with more than one weakening element to create more than one separation point upon separation.
